(19) United States
(12) Patent Application Publication
(10) Pub. No.: US 2017/0181240 A1
(43) Pub. Date: Jun. 22, 2017

(54) HIGH VOLTAGE RESISTANT TRANSMITTING CIRCUIT FOR DEVICES COMMUNICATING ON DALI BUS

(71) Applicant: GENERAL ELECTRIC COMPANY, Schenectady, NY (US)

(72) Inventors: Tamás Darányi, BudaPest (HU); Lajos Csibi, BudaPest (HU); Richárd Boros, BudaPest (HU)

(21) Appl. No.: 14/972,032

(22) Filed: Dec. 16, 2015

(51) Int. Cl. H05B 33/08

(52) U.S. Cl. CPC H05B 33/0848; H05B 33/0812; H05B 33/089

(57) ABSTRACT

An apparatus includes a transmitting circuit and a power supply connected to a digital lighting interface bus, and a protection circuit configured to provide a first signal operable to disconnect the power supply and a second signal operable to disable the transmitting circuit when a voltage on the digital lighting interface bus exceeds a predetermined threshold. A method includes sensing a voltage on a digital lighting interface bus, and upon detecting that the voltage exceeds a predetermined threshold, providing a first signal operable to disconnect a power supply connected to the digital lighting interface bus and providing a second signal operable to disable a transmitting circuit supply connected to the digital lighting interface bus.

The disclosed exemplary embodiments relate generally to lighting control systems, and more particularly to protection circuits for interfacing digital communication busses of lighting systems.

### BACKGROUND

Lighting for homes, offices, commercial spaces, and public areas may be controlled to account for occupancy and ambient light at the light fixture, workstation, room, floor and building levels. Some systems have been implemented using the Digital Addressable Lighting Interface (DALI) which is a global standard for a lighting control data protocol and transport mechanism maintained as IEC 62386. The DALI standard specifies a two wire, bi-directional data bus connecting a DALI application controller with up to 64 DALI controlled devices, referred to as control gear. The control gear may include ballasts, occupancy sensors, photo sensors, wall switches, dimmers, and other devices controlled by the DALI application controller. The data bus cable is mains rated and may be run next to mains conductors or in a cable with mains conductors. The DALI control gear are individually addressable and data is transferred between the application controller and a control gear using an asynchronous, half-duplex, serial protocol. Data is transmitted using Manchester encoding at a fixed data transfer rate of 1200 bits/s to ensure reliable communications. The DALI bi-directional data bus also provides power at up to 22 volts and 250 mA maximum current. DALI application controllers and control gear may be connected in a star or daisy chain configuration.

FIG. 1 shows a block diagram of an exemplary DALI system 100. An application controller 105 is connected to a number of DALI control gear 110₀-110₆₃ by the bi-directional data bus 115. DALI control gear 110₀-110₆₃ may control light sources 125 or other equipment or may be implemented as occupancy sensors, light sensors, wall switches or other lighting appliances. Mains power is provided through mains cable 120. In some implementations, mains power is provided by, or controlled by, application controller 105. Some implementations of DALI control gear 110₀-110₆₃ may not require mains power but instead may derive power from the DALI bi-directional data bus, allowing for less complicated installation.

FIG. 2 shows a block diagram of at least a portion of an exemplary DALI control gear 205 similar to control gear 110₀-110₆₃. DALI control gear 205 may include a bus interface 210 and operating circuitry 215. Bus interface 210 may isolate the operating circuitry 215 from the bi-directional data bus 115 using a diode bridge 220 and optocouplers 225, 230. In some embodiments resistor networks (not shown) may be used in place of the optocouplers. The diode bridge 220 operates to provide a rectified bi-directional data bus 115R. A receiving circuit 235 may be used for receiving commands or messages from application controller 105 to the control gear 205 and may provide the received commands or messages to the operating circuitry 215 through optocoupler 225. A transmitting circuit 240 may be driven by a signal 245 from optocoupler 230 for transmitting responses and messages from the control gear 205 to the application controller 105. The bus interface 210 may also include a power supply 250 that provides power 255 from the rectified bi-directional bus 115R to one or more of the bus interface 210 and the operating circuitry 215. The operating circuitry 215 of the control gear 205 may include a computer 260, for example, a single chip microcontroller with a processor and memory 265 for exchanging information over the DALI bi-directional data bus 115 and for controlling lamps and other lighting equipment.

FIG. 3 shows a schematic diagram of a portion of the bus interface 210 of control gear 205 including an example of transmitting circuit 240 and an example of power supply 250. The transmitting circuit 240 includes a semiconductor driver 305 driven by the signal 245 from optocoupler 230. The power supply 250 includes one or more electrical storage devices 310, for example capacitors, batteries, or other components for storing electricity. Power from the rectified bidirectional data bus 115R is used to charge the electrical storage devices 310 through diode 315. The voltage applied to the electrical storage devices 310 is this example may be controlled by a regulator 320. Power supply 250 then provides power through conductor 255 to one or more of the bus interface 210 and the operating circuitry 215.

However, with this type of architecture, misconnection of the mains voltage could be capable of causing damage to the bus interface 210. In some failure modes, if the mains voltage 120A, 120B is connected to the bi-directional data bus 115, the voltage on the bi-directional data bus 115 and the rectified bi-directional data bus 115R could reach mains voltage, for example, between 110 and 240 volts, considerably exceeding the rated voltage of 22 volts. Similar problems may result if the mains voltage 120A, 120B is connected directly to the rectified bi-directional data bus 115R. Such voltage may damage at least the components of the transmitting circuit 240, the power supply 250, and circuitry receiving power through conductor 255, resulting in permanent damage to the control gear 205. Referring to FIG. 1, it is possible that any number of the DALI control gear 110₀-110₆₃ may be damaged and need replacement.

It would be advantageous to provide protection for this type of failure condition.

### SUMMARY

The disclosed embodiments are directed to an apparatus including a transmitting circuit and a power supply connected to a digital lighting interface bus, and a protection circuit configured to provide a first signal operable to disconnect the power supply and a second signal operable to disable the transmitting circuit when a voltage on the digital lighting interface bus exceeds a predetermined threshold.

The protection circuit may include a sensing circuit connected to the digital lighting interface bus and configured to provide the first and second signals.

The sensing circuit may include a resistor network in series with a zener diode network.

The predetermined threshold may be determined by a breakdown voltage of the zener diode network.

The first signal may be provided by the resistor network and the second signal may be provided by the zener diode network.

The protection circuit may also include a first switch controlled by the first signal and operable to disconnect the power supply circuit by connecting a control signal of the power supply circuit to a first side of the digital lighting interface bus.

The control signal may be operable to control a current controlled charging circuit of the power supply.

The protection circuit may further include a second switch controlled by the second signal and operable to disable the transmitting circuit by connecting an input of the transmitting circuit to a second side of the digital lighting interface bus.

The input of the transmitting circuit may be operable to control a semiconductor driver of the transmitting circuit.

The disclosed embodiments are also directed to a method including sensing a voltage on a digital lighting interface bus, and upon detecting that the voltage exceeds a predetermined threshold, providing a first signal operable to disconnect a power supply connected to the digital lighting interface bus and providing a second signal operable to disable a transmitting circuit supply connected to the digital lighting interface bus.

The method may include using a sensing circuit connected to the digital lighting interface bus to provide the first and second signals.

The sensing circuit may include a resistor network in series with a zener diode network.

The method may include using a breakdown voltage of the zener diode network to determine the predetermined threshold.

The method may also include using the resistor network to provide the first signal and using the zener diode network to provide the second signal.

The method may further include disconnecting the power supply circuit by connecting a control signal of the power supply circuit to a first side of the digital lighting interface bus.

The control signal may be operable to control a current controlled charging circuit of the power supply.

The method may still further include disabling the transmitting circuit by connecting an input of the transmitting circuit to a second side of the digital lighting interface bus side.

The input of the transmitting circuit may be operable to control a semiconductor driver of the transmitting circuit.

### BRIEF DESCRIPTION OF THE DRAWINGS

FIG. 1 shows a block diagram of an exemplary digital addressable lighting interface (DALI) system;

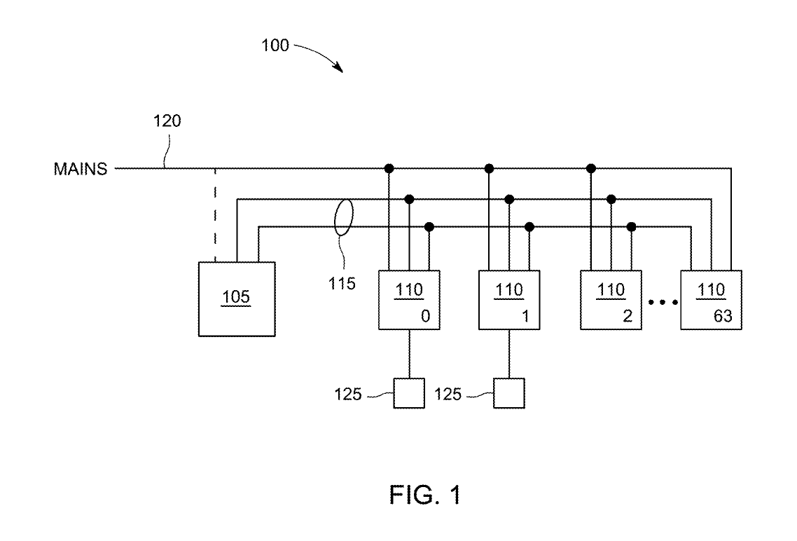

FIG. 2 shows a schematic diagram of at least a portion of an exemplary DALI control gear;

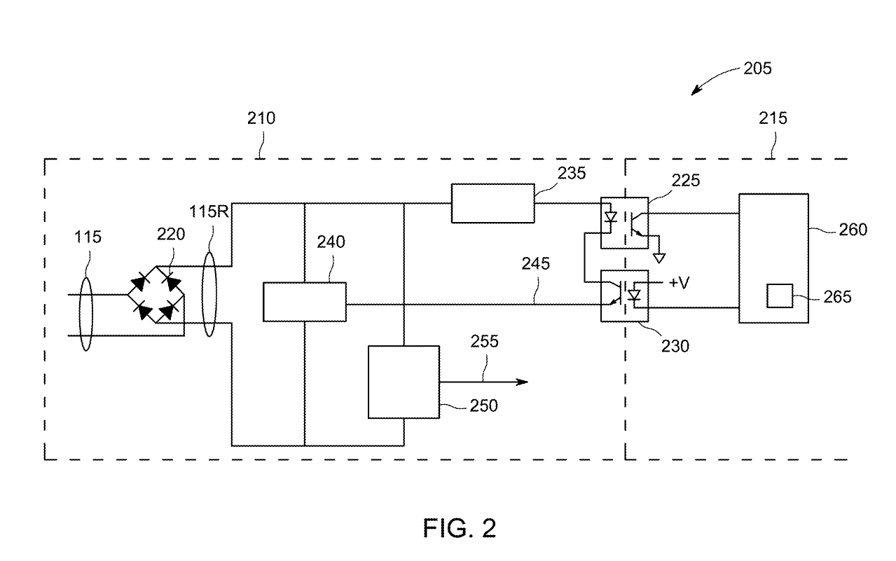

FIG. 3 shows a schematic diagram of a portion of a bus interface of the control gear;

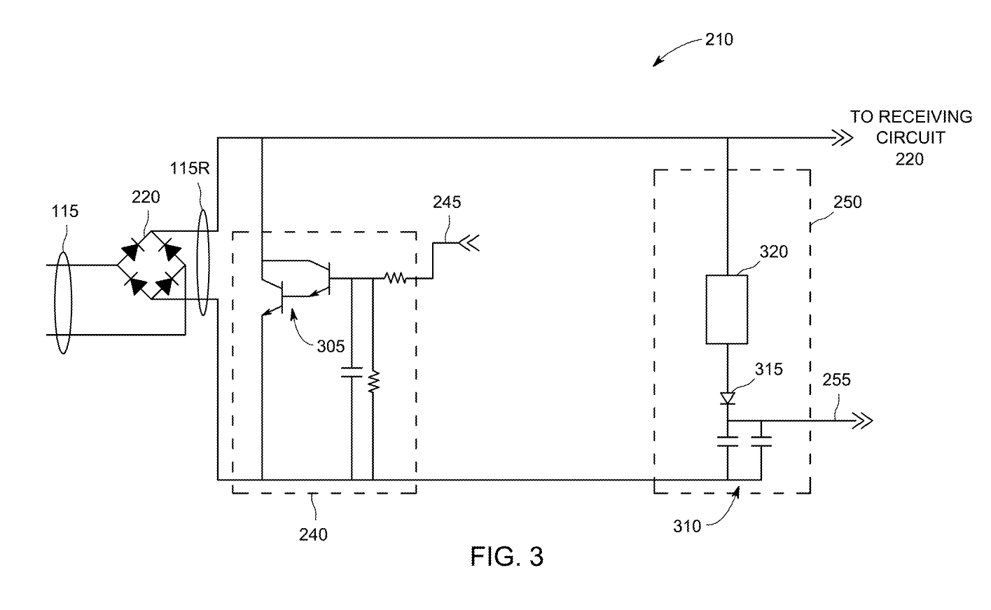

FIG. 4A shows a schematic diagram of a portion of a DALI bus interface incorporating the structures and techniques disclosed herein; and

FIG. 4B shows a block diagram of an exemplary protection circuit according to the disclosed embodiments;

FIG. 5 shows an example of a sensing circuit according to the disclosed embodiments; and

FIG. 6 shows a diagram of a method according to the disclosed embodiments.

### DETAILED DESCRIPTION

The embodiments disclosed herein are directed to providing a transmitting circuit and a power supply that are resistant to high voltages that may be applied to the bi-directional bus. In one or more aspects, the present embodiments utilize a protection circuit to automatically disable the transmitting circuit and disconnect the power supply when the voltage on the bidirectional bus exceeds a threshold.

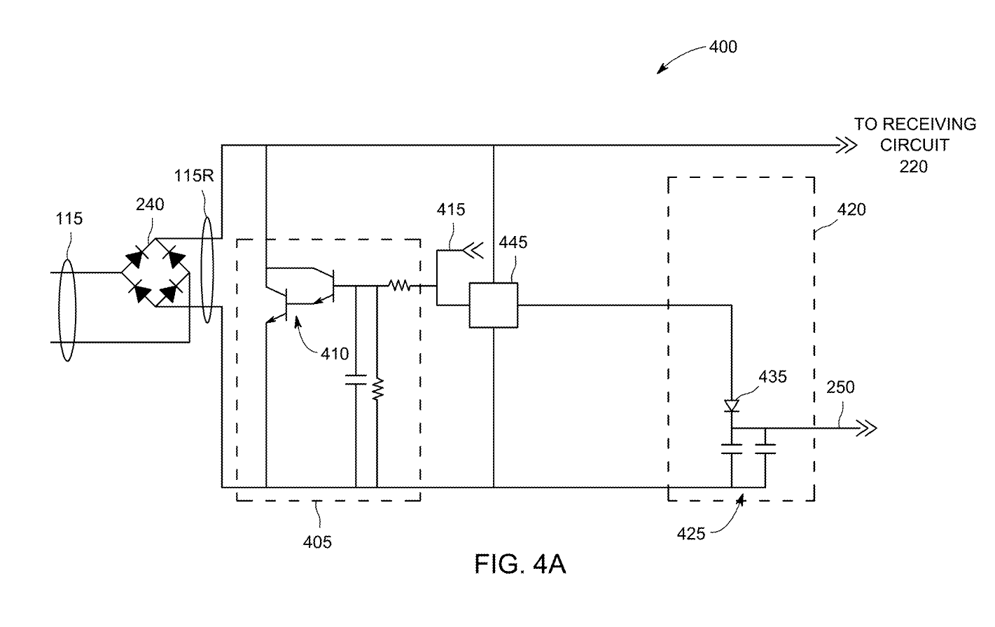

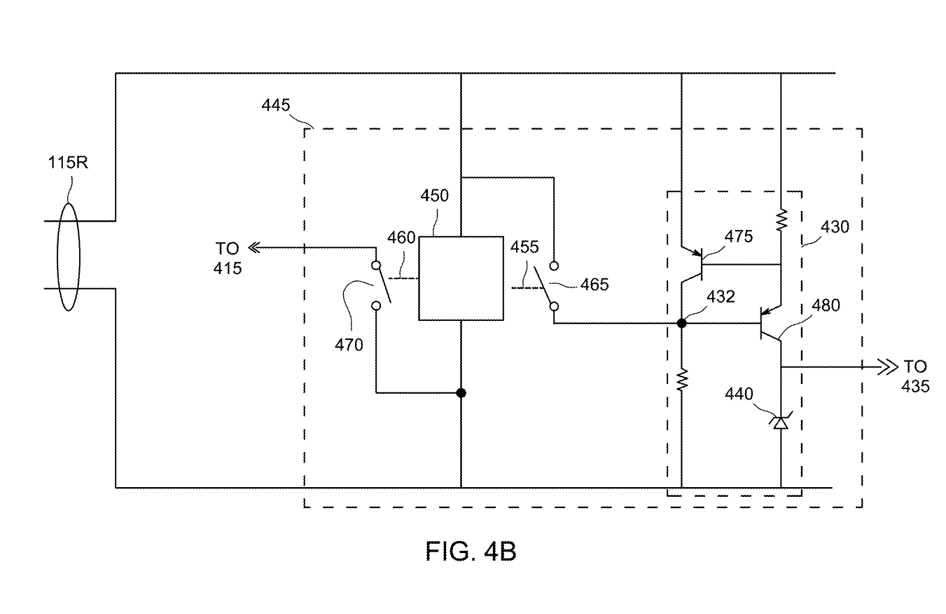

FIG. 4A shows a schematic diagram of a portion of a DALI bus interface 400 incorporating the structures and techniques disclosed herein. The DALI bus interface 400 may include a transmitting circuit 405 with a semiconductor driver 410, for example, a Darlington stage, driven by signal 415 from a transmitting optocoupler such as optocoupler 230 of the operating circuitry 215. As mentioned above, in some embodiments, a resistor network (not shown) may be used in place of optocoupler 230. The DALI bus interface 400 may also include a power supply 420 having one or more electrical storage devices 425 and a diode 435. As a result of the illustrated embodiment of bus interface 400, connecting the mains voltage to the bi-directional data bus 115 or rectified bi-directional data bus 115R may cause damage to the transmitting circuit 405 and the power supply 420. In some failure modes, the voltage on the bi-directional data bus 115 and the rectified bi-directional data bus 115R could reach a voltage, for example, of between 110 and 240 volts, considerably exceeding the rated voltage of 22 volts. Such voltage may damage at least the components of the transmitting circuit 405, the power supply 420, and any other circuitry receiving power through conductor 255, and may result in permanent damage to the bus interface 400 and a control gear including the bus interface 400.

The disclosed embodiments include a protection circuit 445 that operates to charge the one or more electrical storage devices 425 and provides protection against an application of mains power or other over voltage condition on the bidirectional bus 115 or rectified bi-directional data bus 115R that might cause damage to the transmitting circuit 405, power supply 420, and a control gear including these components.

FIG. 4B shows a block diagram of an example of protection circuit 445. In at least one embodiment, protection circuit 445 may include a constant current charging circuit 430 and a sensing circuit 450 connected to the rectified bi-directional data bus 115R. The electrical storage devices 425 may be charged by the current controlled charging circuit 430 through diode 435. The current controlled charging circuit 430 may include switches 475, 480 controlled by a voltage applied to a control node 432 connecting a collector of switch 475 with a base of switch 480. Zener diode 440 may operate to limit the charging voltage applied to the electrical storage devices 425. In at least one embodiment zener diode 440 may have an approximate breakdown voltage of 22 volts. When a voltage on the rectified bi-directional data bus 115R exceeds a predetermined threshold, the sensing circuit 450 may operate to generate a signal 455 operable to disconnect the power supply 420 from the rectified bi-directional data bus 115R and to generate a signal 460 operable to disable the transmitting circuit 405. In at least one embodiment, the protection circuit 445 may include a switch 465 connected to the control node 432 of the current controlled charging circuit 430, and a switch 470 connected to signal 415 of the transmitting circuit 405. In operation, switches 465 and 470 may be normally open. When a voltage on the rectified bi-directional data bus 115R exceeds a predetermined threshold, the sensing circuit 450 may utilize signals 455 and 460 to close switches 465 and 470, respectively, in order to disconnect the power supply 420 and disable the transmitting circuit 405, as will be explained in detail below. An exemplary predetermined threshold may be approximately 35 volts or any other suitable threshold.

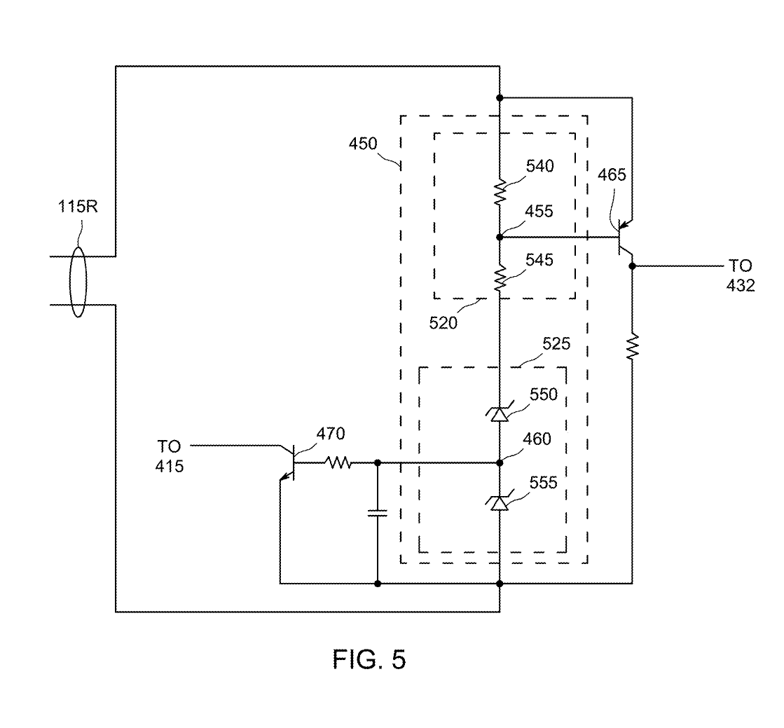

FIG. 5 shows an example of sensing circuit 450 according to the disclosed embodiments. The sensing circuit 450 may include, in series, a resistor network 520 and a zener diode network 525. The resistor network 520 may provide signal 455 operable to disconnect power supply 420 and the zener diode network 525 may provide signal 460 for disabling transmitter circuit 405. In at least one embodiment, resistor network 520 may include resistors 540 and 545 and signal 455 may be provided from a node connecting the two resistors. In some embodiments, zener diode network may include zener diodes 550 and 555 and signal 460 may be provided from a node connecting the two diodes. In at least one embodiment, the value of resistor 545 may be a multiple of the value of resistor 540 and in some embodiments, the breakdown voltage of zener diode 550 may be higher that the breakdown voltage of zener diode 555. The values of resistors 540 and 545 may be selected such that when the breakdown voltage of the diode network is exceeded, signal 455 provides a voltage that maintains switch 465 in an on or conducting state. The breakdown voltages of zener diodes 550 and 555 may be selected such that when a voltage on the rectified bi-directional data bus 115R exceeds a predetermined threshold, signal 460 provides a voltage that maintains switch 470 in an on or conducting state. Exemplary values for resistors 540 and 545 may include approximately 47K ohms and 150K ohms, respectively, and exemplary breakdown voltages for zener diodes 550 and 555 may include approximately 30 volts and 4.7 volts, respectively. It should be understood that resistor network 520 may include any number of resistors and diode network 525 may include any number of diodes suitable for implementing the disclosed embodiments, and that the resistors and diodes may have any values suitable for providing the sensing capabilities of the sensing circuit 515.

During normal operation switch 465 may be open and non-conducting, and power supply 420 may operate to charge electrical storage devices 425 using current controlled charging circuit 430. Current controlled charging circuit 430 may deliver current to the electrical storage devices 425 through diode 435. Zener diode 440 may operate to limit the charging voltage applied to the electrical storage devices 425 and in at least one embodiment may have an approximate breakdown voltage of 22 volts. The power supply 420 may deliver power to one or more of circuitry in the bus interface 400 and operating circuitry 215. During normal operation switch 470 may also be open and non-conducting, and semiconductor driver 410 of transmitting circuit 405 may be driven by signal 415 from the operating circuitry 215.

In the event of a fault condition where a voltage on the bi-directional data bus 115 or the rectified bi-directional data bus 115R exceeds a predetermined threshold, sensing circuit 450 may cause switches 465 and 470 to close and become conducting. In at least one embodiment, the predetermined threshold may be determined by the breakdown voltage of zener diode 550 and the breakdown voltage of zener diode 555. In some embodiments, the predetermined threshold may be a combined breakdown voltage of approximately 34.7 volts. In this example, when the rectified bi-directional data bus 115R voltage exceeds 34.7 volts, the emitter-base voltage of switch 465 will increase causing switch 465 to turn on and conduct, effectively connecting the positive side of the rectified bi-directional data bus 115R to the control signal 432 connected to the base of current controlled charging circuit switch 480. The voltage applied to the base of current controlled charging circuit switch 480 will increase, causing the emitter-base voltage of switch 480 to drop. As a result, switch 480 will open and become non-conducting, isolating the electrical storage devices 425 from the rectified bi-directional data bus 115R.

Concurrently, as the voltage on the bi-directional data bus 115 or the rectified bi-directional data bus 115R exceeds the exemplary predetermined threshold, the voltage across zener diode 555 will cause the base-emitter voltage of switch 470 to increase, resulting in switch 470 turning on and becoming conducting, effectively connecting the negative or ground side of the rectified bi-directional data bus 115R to the base of semiconductor driver 410. The base-emitter voltage of semiconductor driver 410 will drop, causing semiconductor driver 410 to open and become non-conducting, disabling the transmitting circuit 405 and preventing excess current flow through semiconductor driver 410. While the operation of switches and drivers 410, 465, 470, and 480 are described in terms of voltages present at transistor terminals, it should be understood that switches and drivers 410, 465, 470, and 480 may be implemented as any suitable switching devices, including, without limitation, Darlington pairs, transistors, field effect transistors (FETs), or metal oxide semiconductor field effect transistors (MOSFETs).

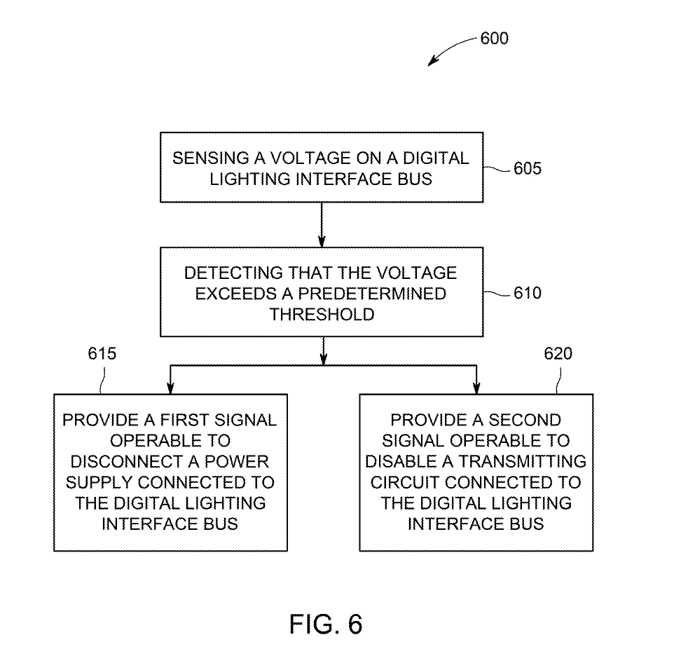

FIG. 6 shows a diagram 600 of a method according to the disclosed embodiments. In block 605, the method includes sensing a voltage on a digital lighting interface bus. The method further includes detecting that the voltage exceeds a predetermined threshold, as shown in block 610. Upon detecting that the voltage exceeds a predetermined threshold, the method includes both providing a first signal operable to disconnect a power supply connected to the digital lighting interface bus, as shown in block 615, and providing a second signal operable to disable a transmitting circuit supply connected to the digital lighting interface bus, as shown in block 620.

While described in the context of applying a mains voltage to a bi-directional DALI bus, it should be noted that the disclosed embodiments may be used to protect any number or type of circuit from an overvoltage condition.

Various modifications and adaptations may become apparent to those skilled in the relevant arts in view of the foregoing description, when read in conjunction with the accompanying drawings. However, all such and similar modifications of the teachings of the disclosed embodiments will still fall within the scope of the disclosed embodiments.

Furthermore, some of the features of the exemplary embodiments could be used to advantage without the corresponding use of other features. As such, the foregoing description should be considered as merely illustrative of the principles of the disclosed embodiments and not in limitation thereof.

1. An apparatus comprising:
a transmitting circuit connected to a digital lighting interface bi-directional data bus and a power supply receiving power from the digital lighting interface bi-directional data bus; and
a protection circuit configured to provide a plurality of signals when a voltage on the digital lighting interface bi-directional data bus exceeds a predetermined threshold including a first signal operable to disconnect the power supply and a second signal operable to disable the transmitting circuit.

2. The apparatus of claim 1, wherein the protection circuit comprises a sensing circuit connected to the digital lighting interface bi-directional data bus and configured to provide the first and second signals.

3. The apparatus of claim 2, wherein the sensing circuit comprises a resistor network in series with a zener diode network.

4. The apparatus of claim 3, wherein the predetermined threshold is determined by a breakdown voltage of the zener diode network.

5. The apparatus of claim 3, wherein the first signal is provided by the resistor network and the second signal is provided by the zener diode network.

6. The apparatus of claim 1, wherein the protection circuit comprises a first switch controlled by the first signal and operable to disconnect the power supply circuit by connecting a control signal of the power supply circuit to a first side of the digital lighting interface bi-directional data bus.

7. The apparatus of claim 6, wherein the control signal is operable to control a current controlled charging circuit of the power supply.

8. The apparatus of claim 1, wherein the protection circuit comprises a second switch controlled by the second signal and operable to disable the transmitting circuit by connecting an input of the transmitting circuit to a second side of the digital lighting interface bi-directional data bus.

9. The apparatus of claim 8, wherein the input of the transmitting circuit is operable to control a semiconductor driver of the transmitting circuit.

10. A method comprising:
sensing a voltage on a digital lighting interface bi-directional data bus;
upon detecting that the voltage exceeds a predetermined threshold, providing a first signal operable to disconnect a power supply receiving power from the digital lighting interface bi-directional data bus and providing a second signal operable to disable a transmitting circuit connected to the digital lighting interface bi-directional data bus.

11. The method of claim 10, comprising using a sensing circuit connected to the digital lighting interface bi-directional data bus to provide the first and second signals.

12. The method of claim 11, wherein the sensing circuit comprises a resistor network in series with a zener diode network.

13. The method of claim 12, comprising using a breakdown voltage of the zener diode network to determine the predetermined threshold.

14. The method of claim 12, comprising using the resistor network to provide the first signal and using the zener diode network to provide the second signal.

15. The method of claim 10, comprising disconnecting the power supply circuit by connecting a control signal of the power supply circuit to a first side of the digital lighting interface bi-directional data bus.

16. The method of claim 15, wherein the control signal is operable to control a current controlled charging circuit of the power supply.

17. The method of claim 10, comprising disabling the transmitting circuit by connecting an input of the transmitting circuit to a second side of the digital lighting interface bi-directional data bus.

18. The method of claim 17, wherein the input of the transmitting circuit is operable to control a semiconductor driver of the transmitting circuit.
